(19) United States
(12) Patent Application Publication
(10) Pub. No.: US 2009/0073839 A1
(43) Pub. Date: Mar. 19, 2009

(54) REPRODUCTION APPARATUS AND METHOD

(75) Inventor: Yukinori Yakuwa, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/205,256

(22) Filed: Sep. 5, 2008

(30) Foreign Application Priority Data
Sep. 14, 2007 (JP) 2007-239852

(51) Int. Cl. G11B 20/18

(52) U.S. Cl. 369/53.44; G9B/20.006

(57) ABSTRACT

According to one embodiment, there is disclosed a reproduction apparatus includes a determination unit determining a preset reproduction limit level of the reproduction apparatus, a generator generating message data in accordance with the reproduction limit level, a reader reading data recorded in a recording medium, a reproduction unit reproducing data read from the reader, a detector detecting a reproduction limit level of the recording medium from data read from the reader, and a display unit comparing the reproduction limit level of the recording medium with the reproduction limit level of the reproduction apparatus, and stopping reproduction of the data of the generator in accordance with the comparison result, and further, displaying a message generated by the generator.

### CROSS-REFERENCE TO RELATED APPLICATIONS

This application is based upon and claims the benefit of priority from Japanese Patent Application No. 2007-239852, filed Sep. 14, 2007, the entire contents of which are incorporated herein by reference.

### BACKGROUND

1. Field

The present invention relates to a reproduction apparatus, which handles reproduction control information of an optical disk, that is, parental information. In particular, the present invention relates to a reproduction apparatus and method for displaying a plurality of messages corresponding to some level parental information.

2. Description of the Related Art

Recently, digital apparatuses have come into wide use; therefore, there have been known various techniques of controlling the operation of the digital apparatus as an operation method produced in accordance with circumstances of these digital apparatuses.

Jpn. Pat. Appln. KOKAI Publication No. 2007-81677 discloses the following television. This television operation is controlled in accordance with viewers. Specifically, the television according to the foregoing technique has the following functions. One is a function of certifying the users, that is, individuals, and changing a character display mode in accordance with the individuals. Another is a function of controlling a message. In this way, operation information such as volume is displayed on a screen using characters in accordance with the certified users.

According to the technique disclosed in the foregoing Publication 2007-81677, the television operation character size displayed on the screen is varied in accordance with individual certified users. However, the following function has not been described therein. According to the function, a protector (or parent) makes a limit in accordance with content reproduction information of an optical disk so that minors cannot view harmful content.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of an optical disk reproduction apparatus according to one embodiment of the present invention;

FIG. 2 is a flowchart to explain a message display procedure of displaying a message when content is reproduced according to a parental function;

FIG. 3 is a flowchart to explain an operation of displaying a message corresponding to a set parental level;

FIG. 4 is a flowchart to explain an operation of displaying a message corresponding to each of 8-level parental levels;

FIG. 5 is a view showing one example of a parental setting screen;

FIG. 6 is a view to explain one example of a message for infants, lower grades, and high grades;

FIG. 7 is a flowchart to explain optical disk registration and reproduction procedures;

FIG. 8 is a view showing one example of a parental setting screen;

FIG. 9 is a block diagram showing the configuration of an optical disk reproduction apparatus having a parental registration function related to an optical disk and a parental function including elapsed time from registration;

FIG. 10 is a flowchart to explain optical disk registration and reproduction procedures;

FIG. 11 is a view showing one example of a parental function setting screen having a growth function according to another embodiment of the present invention;

FIG. 12 is a flowchart to explain the procedure of displaying a message when content is not reproduced according to a parental function having a growth function; and

FIG. 13 is a table (database) showing the correspondence of a parental level used for the parental function having the growth function and age.

### DETAILED DESCRIPTION

Various embodiments according to the invention will be described hereinafter. In general, according to one embodiment of the invention, there is provided a reproduction apparatus comprising: a determination unit determining a preset reproduction limit level of the reproduction apparatus; a generator generating message data in accordance with the reproduction limit level; a reader reading data recorded in a recording medium; a reproduction unit reproducing data read from the reader; a detector detecting a reproduction limit level of the recording medium from data read from the reader; and a display unit comparing the reproduction limit level of the recording medium with the reproduction limit level of the reproduction apparatus, and stopping reproduction of the data of the generator in accordance with the comparison result, and further, displaying a message generated by the generator.

According to the message display when parental lock is issued, the apparatus refer to the parental level to display a message “Let's watch it together with parents”. Therefore, the apparatus can easily select an expression in accordance with a minor's understanding, so that minors can completely understand the message.

Embodiments of the invention will be hereinafter described with reference to the accompanying drawings.

<Optical Disk Reproduction Apparatus According to One Embodiment of the Present Invention>

(Configuration)

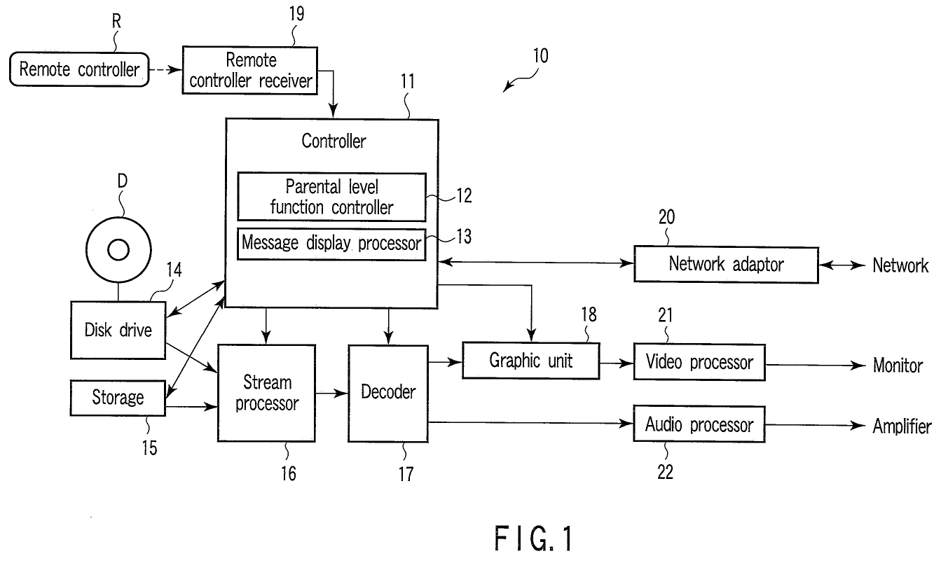

FIG. 1 is a block diagram showing the configuration of an optical disk reproduction apparatus according to one embodiment of the present invention.

A reproduction apparatus 10 according to one embodiment of the present invention includes a controller 11, a parental function controller 12, a message display processor 13, and a disk drive 14. The apparatus 10 further includes a storage 15, a stream processor 16, a decoder 17, a graphic unit 18, a remote controller receiver 19, a network adaptor 20, a video processor 21 and an audio processor 22.

(Operation of Each Component)

The controller 11 controls the whole operation of the apparatus. The parental function controller 12 realizes parental lock.

The foregoing parental lock is a limiting function used by a parent to prevent minors viewing harmful content. Parents preset the parental function, and thereby, the following operation is realized. Specifically, when content is reproduced, the content is selectively reproduced in accordance with a parental level (i.e., reproduction limit level). Further, the parental lock functions to forcedly stop viewing. When the parental lock functions to forcedly stop viewing, a message is displayed. In this case, since viewing minors receives the message, it is difficult to understand the message represented using a general sentence. An child of an age group that includes preschool children finds it difficult to understand any message that involves letters, etc. A child in an age group who has finished compulsory education can be expected to understand a message of a higher complexity.

Thus, the message display processor 13 is provided. As described later, the content limited using parental lock is classified by age group. The classification of the age group is used to automatically select and display a message understandable by the target age group. In particular, an explanation about the age group including preschool children is easily understandable by displaying simple pictures and marks.

The disk drive 14 drives an optical disk D such as an HD DVD to read data. The storage 15 is a memory medium of a hard disk drive or a USB memory. The stream processor 16 handles stream data read from the optical disk D. The decoder 17 decodes the stream data according to MPEG format.

The graphic unit 18 overlaps the operation information with video. The remote controller receiver 19 receives an operation signal from a remote controller R, and then, supplies the signal to the controller 11. The network adaptor 20 connects to a LAN and the Internet to make data communication with external devices. The video processor 21 processes the video signal to display it on a display (not shown). The audio processor 22 processes an audio signal, and supplies the signal to an external speaker (not shown).

<Parental Procedure of Optical Disk Reproduction Apparatus According to One Embodiment of the Present Invention>

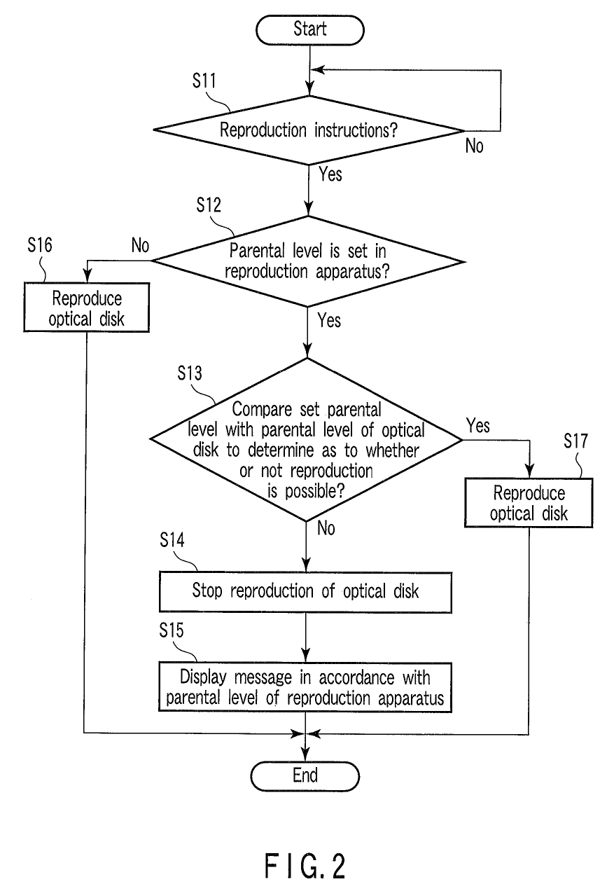

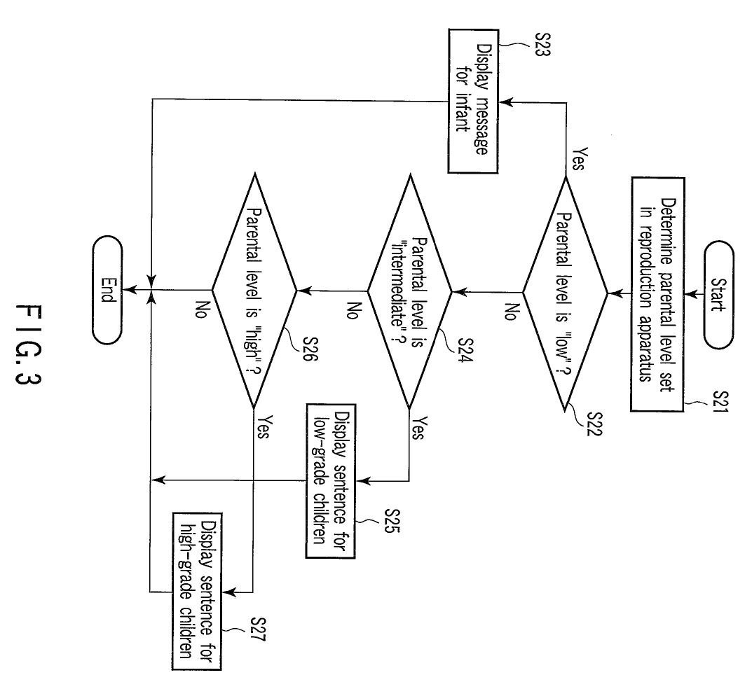

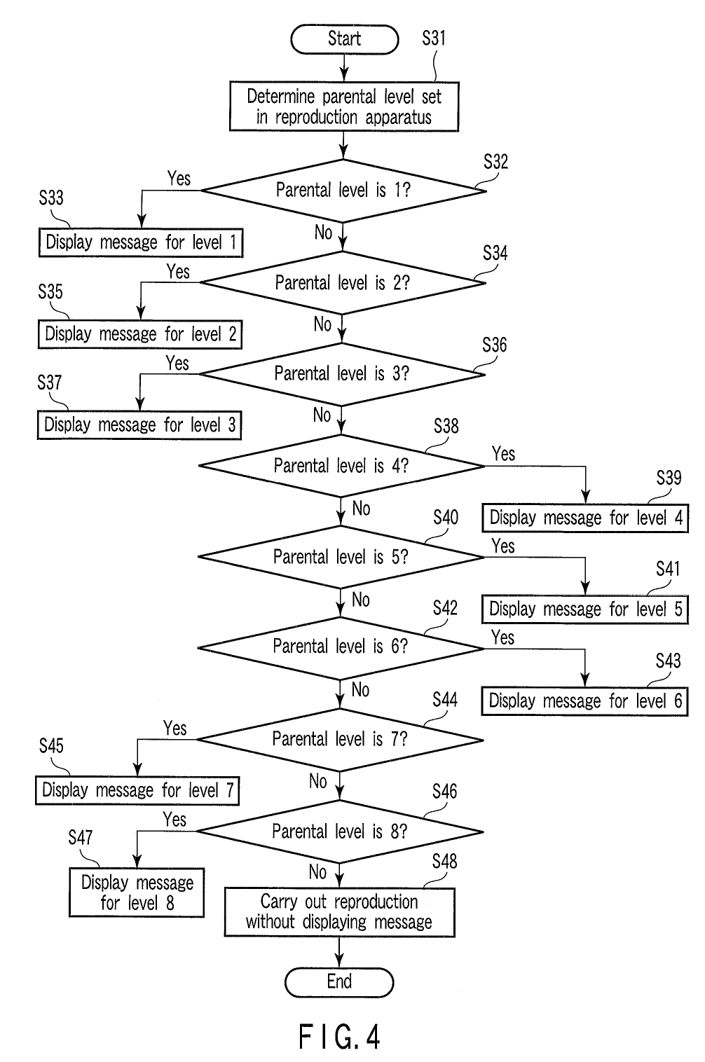

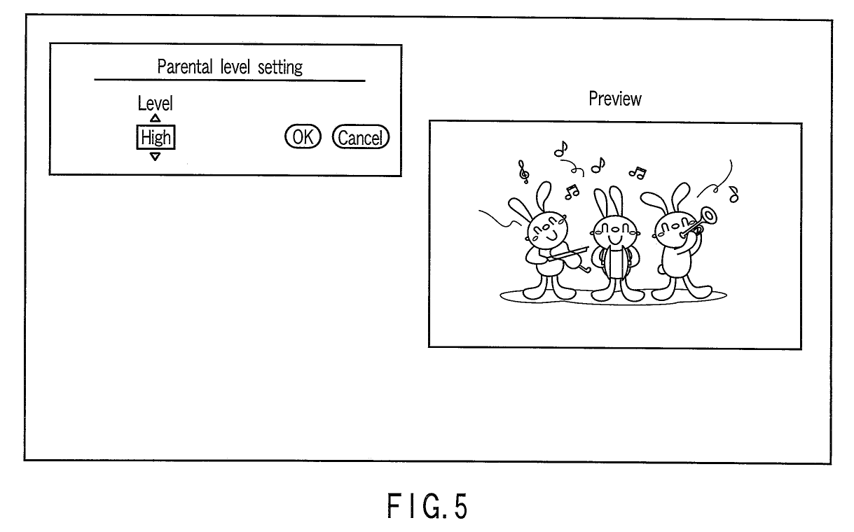

The parental procedure in the foregoing optical disk reproduction apparatus according to one embodiment of the present invention will be described below. FIG. 2 is a flowchart to explain the message display procedure of displaying a message when content is not reproduced according to the parental function. FIG. 3 is a flowchart to explain the operation of displaying a different message in accordance with the set parental level. FIG. 4 is a flowchart to explain the operation of displaying a message corresponding to each of 8-level parental levels. FIG. 5 is a view showing one example of a parental setting screen.

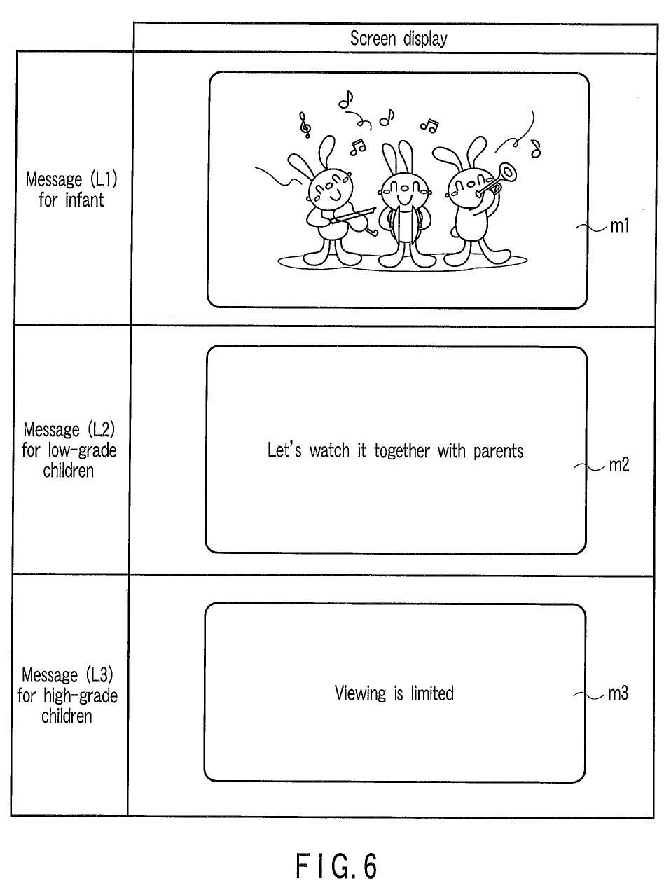

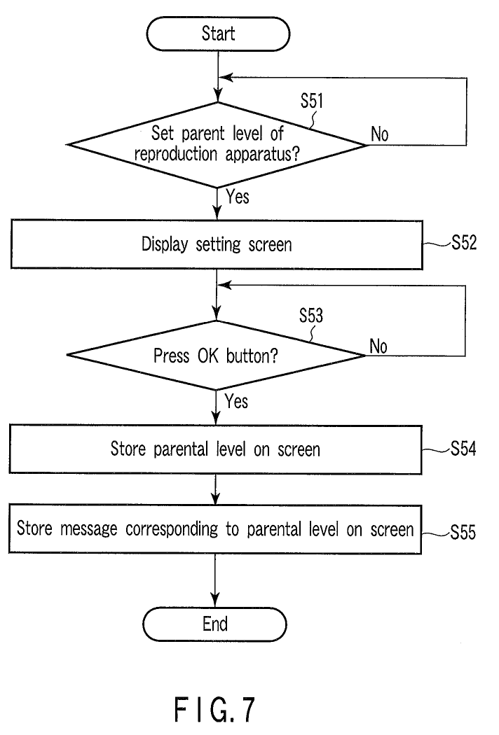

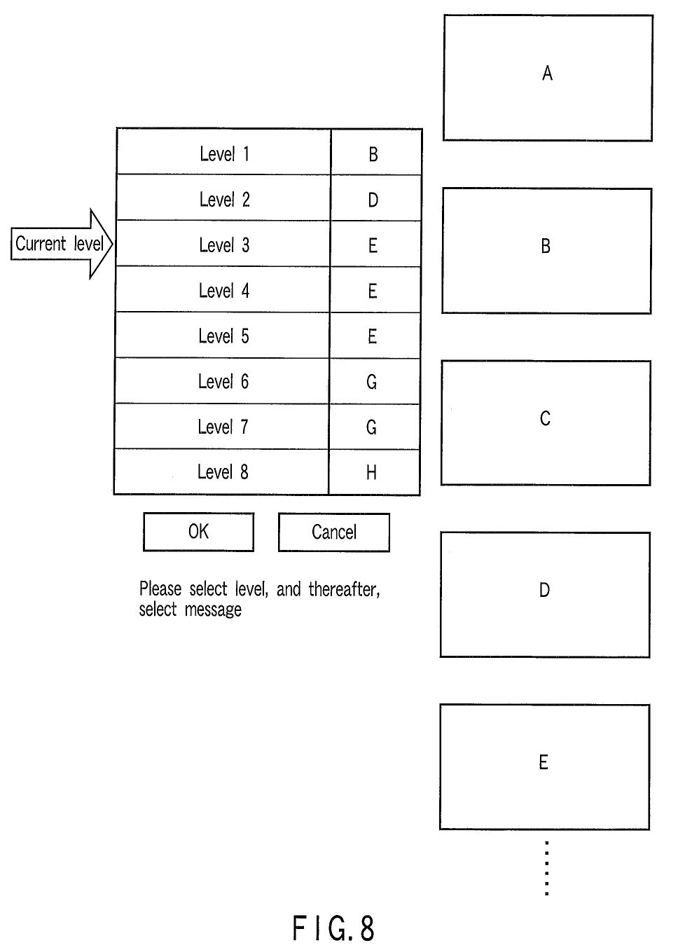

FIG. 6 is a view showing the message for an infant, low-grade children and high-grade children. FIG. 7 is a flowchart to explain optical disk registration and reproduction procedures. FIG. 8 is a view showing one example of a parental setting screen.

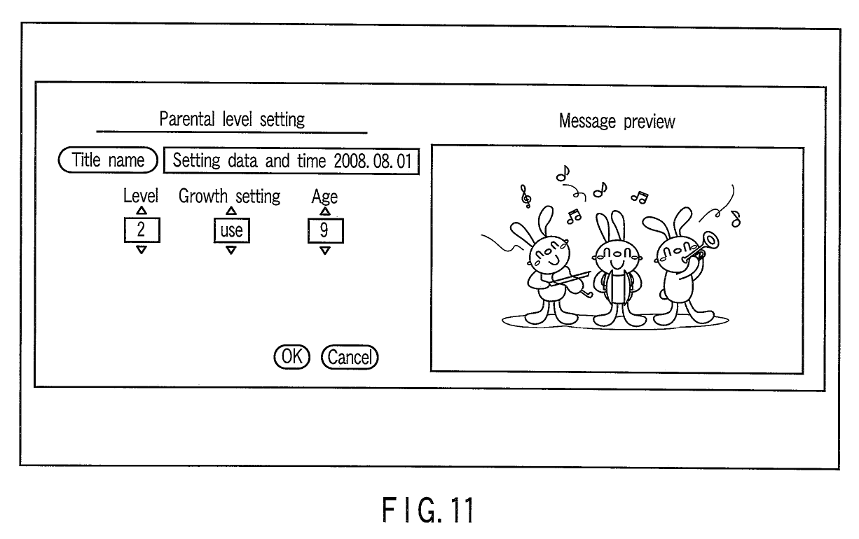

Each step of the flowcharts of FIG. 2 to FIG. 4, FIG. 7 and FIG. 11 is replaced with a circuit block. Thus, the steps of each flowchart are all defined as a block.

(Parental Lock Procedure)

The parental lock procedure of the reproduction apparatus will be described with reference to the flowcharts shown in FIGS. 2 to 4. When reproduction instructions of the optical disk D are received by the remote controller R (step S11), the parental function controller 12 determines whether or not parental level is set to the reproduction apparatus 10 (step S12). If the parental level is not set, a normal optical disk reproduction is carried out (step S16).

In step S12, if the parental level is set, the parental function controller 12 operates the disk drive 14 to read management information from the optical disk. Then, the controller 12 detects the parental level of the optical disk to compare the parental level of the reproduction apparatus with that of the optical disk. If the parental level of the optical disk is within a reproduction apparatus parental level allowable range, the controller 12 determines that the optical disk is reproducible to reproduce the content within the optical disk (step S17).

In this case, if the parental level of the optical disk is within a reproduction apparatus parental level allowable range, the parental level of the reproduction apparatus is the level 3, for example, and the parental level of the optical disk is the level 2 or 0.

If the parental level of the optical disk is out of a reproduction apparatus parental level allowable range; in other words, the parental level of the reproduction apparatus is level 4, for example, and the parental level of the optical disk is level 8. In this case, the parental function controller 12 stops the reproduction of the optical disk (step S14). The message display processor 13 automatically selects and displays a message corresponding to the parental level set in the reproduction apparatus from a plurality of messages (step S15).

The message corresponding to the parental level is a simple registration screen shown in the right side of FIG. 5, and previously stored in a memory area as a message corresponding to the parental level. When the message display processor 13 functions, a message is automatically selected and displayed in accordance with the parental level. FIG. 3 shows the foregoing procedure.

Specifically, if the parental level set in reproduction apparatus is a low level, such as level 1 (step S22), viewers are determined as preschool children from age 0 to 5. Thus, a message m1 for infants of FIG. 6 is displayed (step S23). If the parental level is an intermediate level, such as parental level 2 (step S24), viewers are determined as low-grade children from age 6 to 10. Thus, a message m2 for low-grade children of FIG. 6 is displayed (step S25). If the parental level is a high level, such as parental level 3 (step S26), viewers are determined as high-grade children from age 11 to 15. Thus, a message m3 for high-grade children of FIG. 6 is displayed (step S27).

For example, if there are 8 levels, the foregoing message display procedure corresponding to the level is prepared in detail to correspond to the foregoing 8 levels shown in a flowchart of FIG. 4. Specifically, the message display processor 13 determines a parental level set in the reproduction apparatus (step S31). Then, if the parental level is 1 (step S32), the message display processor 13 displays a message for the level 1 (step S33). If the parental level is 2 (step S34), the message display processor 13 displays a message for the level 2 (step S35). If the parental level is 3 (step S36), the message display processor 13 displays a message for the level 3 (step S37). If the parental level is 4 (step S38), the message display processor 13 displays a message for the level 2 (step S39). If the parental level is 5 (step S40), the message display processor 13 displays a message for the level 5 (step S41). If the parental level is 6 (step S42), the message display processor 13 displays a message for the level 6 (step S43). If the parental level is 7 (step S44), the message display processor 13 displays a message for the level 7 (step S45). If the parental level is 8 (step S46), the message display processor 13 displays a message for the level 2 (step S47).

In this case, the message display processor 13 reproduces normal content without displaying the message if it is determined the parental level dose not belong to which level (step S48).

(Parental Level Setting Procedure)

The reproduction apparatus 10 sets the parental level such as reproduction control information and message according to the following procedure. When parental level setting of the reproduction apparatus is instructed in accordance with user's operation of the remote controller R (step S51), the parental function controller 12 of the reproduction apparatus 10 displays a setting screen shown in FIG. 8 (step S52).

A setting screen shown in FIG. 8 is used, and thereby, the parental level of the reproduction apparatus 10 and a message corresponding to the level are set. The smaller the level number is, the higher the reproduction limit level is. For example, 8 parental levels are prepared. In this case, the user selects one of 8 levels and one of several messages A, B, C, . . . . For example, the user selects the level 3 and the message “E”.

Each message corresponding to each level is previously set to a default, and thus, the user may change this.

When the user selects one parental level and one message, and then, presses an “OK” button, the parental function controller 12 recognizes the foregoing settings (step S53). Specifically, the controller 12 stores the parental level on the screen in a memory area (step S54), and stores the message corresponding to the parental level on the screen (step S55).

The foregoing setting screen is used, and thereby, the user can optionally select the parental level and message. Therefore, even if the parental level is level 2, for example, it is possible to display the message for high-grade children requiring character understanding to a degree expected by a user.

According to the foregoing embodiment, the parental level and the message that is understandable to persons of the target age group are set in the reproduction apparatus. According to the parental lock function, content viewing is limited, and further, the corresponding message is displayed. In particular, an explanation for an age group including preschool children is easily understood by displaying simple graphical symbols or picture and mark.

<Parental Registration Procedure for Optical Disk of Optical Disk Reproduction Apparatus According to One Embodiment of the Present Invention>

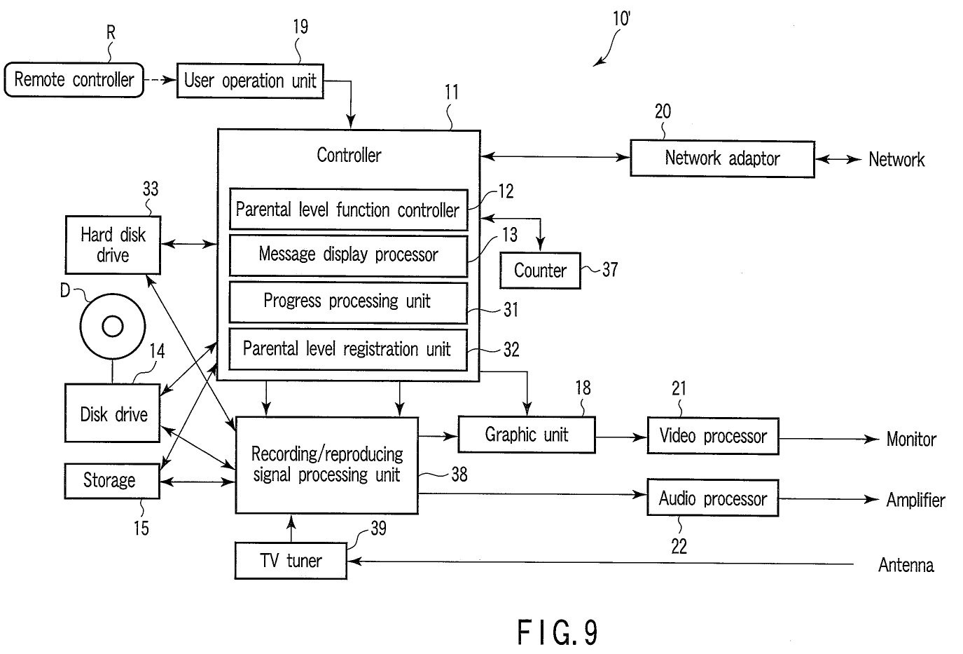

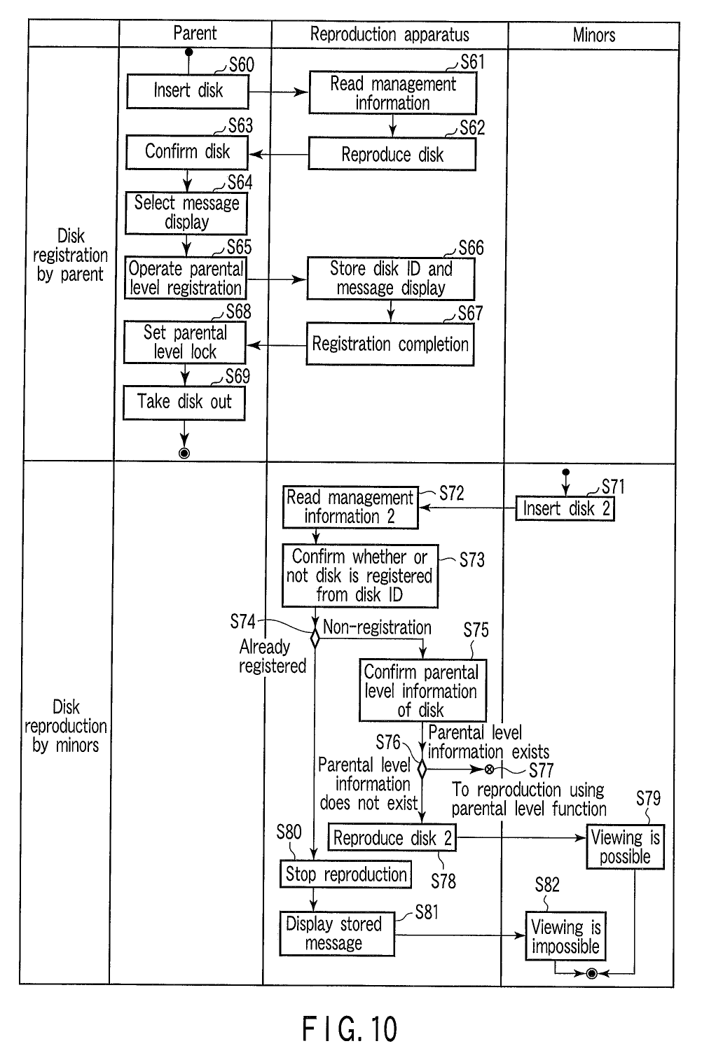

FIG. 9 is a block diagram showing the configuration of an optical disk reproduction apparatus having a parental registration function for an optical disk, and a parental function that accounts for time elapsed from registration. FIG. 10 is a flowchart to explain an optical disk registration and reproduction procedure.

(Configuration)

As shown in FIG. 9, a reproduction apparatus 10′ according to one embodiment of the present invention includes a controller 11, a parental function controller 12, a message display processor 13, a progress processing unit 31, and a parental registration unit 32. The reproduction apparatus 10′ further includes a hard disk drive 33, a disk drive 14, a storage 15, a counter 37, and a recording/reproducing signal processing unit 38. The reproduction apparatus 10′ further includes a TV tuner 39, a graphic unit 18, a remote controller receiver 19, a network adaptor 20, a video processor 21, and an audio processor.

(Operation of Each Component)

The reproduction apparatus 10′ shown in FIG. 9 has substantially the same configuration as that shown in FIG. 1. Therefore, the operation of different configuration components will be described below.

The progress processing unit 31 has a function of automatically updating the parental level in accordance with elapsed time after parental level registration. The parental registration unit 32 forcedly registers a parental level in an optical disk D having no registered parental level. Thereafter, the unit 32 carries out parental lock in accordance with the registered parental level in a reproduction operation.

The hard disk drive 33 records and reproduces content data. The recording/reproducing signal processing unit 38 processes stream data read from an optical disk D and the hard disk drive 33. For example, the unit 38 decodes the stream data according the MPEG format. The TV tuner 39 receives a broadcast signal via an antenna, and outputs a video/audio signal.

(Parental Registration Procedure of Optical Disk)

An optical disk registration procedure and a parental lock procedure in the optical disk reproduction apparatus having the foregoing configuration will be described below. FIG. 10 is a flowchart to explain optical disk registration and reproduction procedures in an optical disk reproduction apparatus according to one embodiment of the present invention.

When the parent, that is, the user inserts an optical disk D in the disk drive 14 (step S60), the disk drive 14 reads management information from the optical disk D (step S61), and then, reproduces this (step S62).

The parent, that is, the user confirms the content of the disk, and as a result, determines that this disk requires parental lock (reproduction control) (step S63). In this case, the user operates the remote controller R to display the messages shown in FIG. 6 on the screen, and then, selects a desired message from these messages (step S64).

The parent, that is, the user operates the remote controller R to forcedly make parental registration with respect to the optical disk D (step S65). In accordance with this operation, the parental registration unit 32 stores the correspondence of the optical disk ID and the selected message in a memory area of the parental registration unit 32 (step S66). In this way, the optical disk parental registration procedure by the parental registration unit 32 is completed (step S67).

The parent, that is, the user operates the remote controller R to set a parental lock operation mode (step S68). According to the operation mode, the parental function controller 12 sets the current operation mode to a parental lock operation mode in accordance with parental registered in the optical disk D. Thereafter, the parent, that is, the user takes this disk out (step S69).

When a minor user inserts this disk D (step S71), the disk drive 14 and the controller 11 of the reproduction apparatus 10′ read management information of the optical disk D (step S72). The parental function controller 12 reads management information, that is, a disk ID from the memory area of the parental registration unit 32 to confirm whether or not the optical disk is previously registered (step S73).

If the parental function controller 12 determines that the optical disk is already registered (step S74), the controller 12 stops reproduction of the optical disk (step S80). Simultaneously, the controller 12 displays a message stored in the memory area of the parental registration unit 32 corresponding to the ID on the screen (step S81). As a result, such minor user knows that viewing the optical disk is not possible (step S82).

Conversely, if the parental function controller 12 determines that parental information is not registered in the optical disk (step S74), the controller 12 confirms normal parental information of the optical disk (step S75). If the parental information exists (step S76), reproduction using the foregoing normal parental function described in the flowchart of FIG. 2 to FIG. 4 is carried out (step S77).

Conversely, if the parental function controller 12 determines that parental information does not exist (step S76), normal optical disk reproduction is carried out (step S78). In this way, a minor user can view the optical disk (step S79).

As described above, even if parental information is previously added to the optical disk on the maker side, the reproduction apparatus 10′ forcedly stores control information in the memory area in accordance with the optical disk ID. In other words, the reproduction limit procedure is carried out with respect to an optical disk having no preset parental information.

In the optical disk forced parental registration procedure, the parental level is not set. However, according to the embodiment, preferably, the parental level may be set. In this case, parental lock is properly carried out in accordance with the comparison result of the set parental level with the parental level of the reproduction apparatus. The message is automatically or optionally displayed in accordance with the level.

<Parental Procedure with Progress Processing of Reproduction Apparatus According to One Embodiment of the Present Invention>

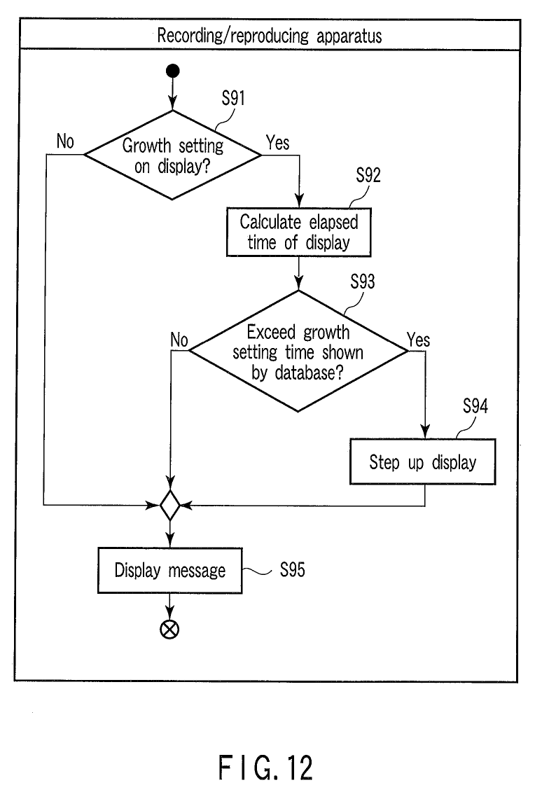

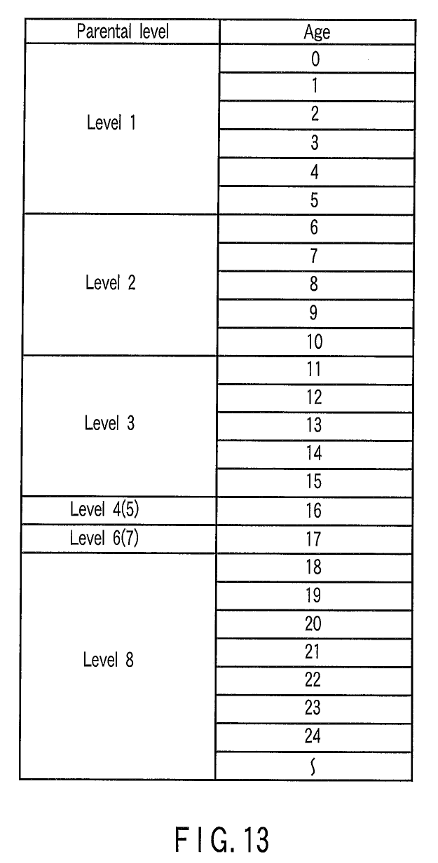

FIG. 11 is a view showing one example of a parental function setting screen having a growth function according to one embodiment of the present invention. FIG. 12 is a flowchart to explain the procedure of displaying a message when content is not reproduced according to a parental function having a growth function. FIG. 13 is a correspondence table (database) of parental levels used for the parental function with growth function and age.

In the reproduction apparatus 10′, growth function setting on a parental setting screen shown in FIG. 11 is set to “use”, and thereby, the growth function is set as control information stored in a memory area.

The foregoing setting screen is used, and thereby, setting date and time, parental level, nonuse or use of growth function setting and user age to be protected are set. For example, the user age to be protected is input, and thereby, the parental level may be uniquely determined based on a database of FIG. 13, and the user may optionally give the parental level.

The progress processing unit 31 identifies the growth setting according to the control information as seen from the flowchart of FIG. 12 (step S91). When the growth setting is identified, the parental function controller 12 of the reproduction apparatus 10′ calculates elapsed time based on the set date and time and the current date and time (step S92). The progress processing unit 31 determines whether or not the elapsed time obtained by the foregoing calculation exceeds the time for updating the level based on the correspondence table (database) shown in FIG. 13 (step S93). The correspondence table (database) shows the correspondence of the parental level with age used for the parental function with growth function.

Specifically, the setting screen of FIG. 11 is used, and thereby, for example, the date is set as Aug. 1, 2008, and the age is set as 9. According to the foregoing set age of 9, the parental level is automatically set to “2” based on the correspondence table (database) shown in FIG. 13.

For example, on Aug. 1, 2010 after two years have elapsed from the set date of Aug. 1, 2008, the progress processing unit 31 updates the user's estimated age of 9 to age 11. Thus, the parental level “2” is automatically updated to “3” based on the correspondence table (database) (step s94). The parental level thus automatically updated is used for the foregoing parental lock.

Preferably, when the progress processing unit 31 functions, the automatic update is displayed on the screen whenever automatic update of age and parental level is made (step S95).

As is evident from the foregoing description, a convenient function of updating the parental level to a proper level without the user having to update the parental level when time elapses, is provided to the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproduction apparatus comprising:
a determination unit which determines a preset reproduction limit level of the reproduction apparatus;
a generator which generates message data in accordance with the reproduction limit level;
a reader which reads data recorded in a recording medium;
a reproduction unit which reproduces data read from the reader;
a detector which detects a reproduction limit level of the recording medium from data read by the reader; and
a display unit which compares the reproduction limit level of the recording medium with the reproduction limit level of the reproduction apparatus, and stops reproduction of the data of the reproduction unit in accordance with the comparison result, and further, displaying a message generated by the generator.

2. The apparatus according to claim 1, wherein the display unit stops reproduction of the data of the reproduction unit when a reproduction limit level of the recording medium is higher than that of the reproduction apparatus, and displays a message generated by the generator.

3. The apparatus according to claim 1, wherein the display unit displays a plurality of reproduction limit levels and a plurality of messages corresponding to the reproduction limit levels,
the reproduction apparatus includes a setting unit, which sets one of the levels as a reproduction limit level of the reproduction apparatus, and sets one of the messages as the displayed message.

4. The apparatus according to claim 3, wherein the display unit generates image information showing the reproduction limit levels and image information showing the messages.

5. The apparatus according to claim 1, wherein the reproduction limit levels are 8 levels.

6. The apparatus according to claim 1, wherein message data generated by the generator includes a message comprising image information only and a message comprising character information only.

7. The apparatus according to claim 1, further comprising:
a unit which determines a reproduction limit level of the reproduction apparatus in accordance with a given age information, and updates the age information in accordance with time progress, and further, updates a reproduction control information level in accordance with the updated age information.

8. A reproduction apparatus comprising:
a reader which reads data recorded in a recording medium;
a medium setting unit which identifies the recording medium, and sets a reproduction limit level of the recording medium and a message;
a reproduction unit which reproduces data read from the reader; and
a controller which stops reproduction of the data of the reproduction unit when the reader reads a recording medium and the recording medium is the recording medium set by the medium setting unit, and outputs image information for displaying the set message.

9. A reproduction method comprising:
setting one from a plurality of reproduction limit levels as a reproduction limit level of a reproduction apparatus;
preparing a plurality of messages corresponding to the reproduction limit levels;
selecting one message corresponding to the set level;
reading data recorded in a recording medium and a reproduction limit level of the recording medium;
comparing the reproduction limit level of the recording medium with that of the reproduction apparatus, and in accordance with the comparison result, stopping reproduction of data read from the recording medium; and
displaying the selected message.

10. The method according to claim 9, wherein a comparison is made between the reproduction limit level of the recording medium with that of the reproduction apparatus, and when a reproduction control information level of the recording medium is higher than the reproduction limit level of the reproduction apparatus, reproduction of the data is stopped to display the selected message.
